(19) United States
(12) Patent Application Publication
(10) Pub. No.: US 2026/0235782 A1
(43) Pub. Date: Aug. 13, 2026

(54) NON-CONTACT RELATIVE DEPTH DERIVATION FOR SEISMIC NODES ON A SEAFLOOR SURFACE

(71) Applicant: FNV IP B.V., Leidschendam (NL)

(72) Inventors: Billy Frank GARDNER, Houston, TX (US); Richard Brett SIMPSON, Houston, TX (US)

(73) Assignee: FNV IP B.V., Leidschendam (NL)

(21) Appl. No.: 19/048,702

(22) Filed: Feb. 7, 2025

(51) Int. Cl. G01V 1/38; G06T 7/50; G06T 7/73; G06V 20/05

(52) U.S. Cl. CPC G01V 1/3835; G06T 7/50; G06T 7/73; G06V 20/05; G06T 2207/30244

(57) ABSTRACT

Described are systems and techniques for determining relative depth. A camera system attached to a moveable subsea unit can obtain image data of a scene associated with seismic nodes on the seafloor. The image data is analyzed to detect a configured tracking pattern attached to a respective seismic node of the plurality. Depth information corresponding to the moveable subsea unit is determined based on sensor data obtained from one or more pressure sensors attached to the moveable subsea unit. Using the image data, relative positioning information is determined between the camera system and the configured tracking pattern detected within the scene. The depth information and the relative positioning information are combined to determine a derived depth of the respective seismic node deployed on the seafloor surface. Unlocking insights from Geo-Data, the present invention further relates to improvements in sustainability and environmental developments: together we create a safe and liveable world.

### FIELD

The present disclosure generally relates to subsea monitoring. For example, aspects of the present disclosure are related to systems and techniques for determining relative depth information of seismic nodes deployed on a seafloor surface, based on non-contact relative depth derivation performed for each seismic node by a moveable subsea unit. Unlocking insights from Geo-Data, the present invention further relates to improvements in sustainability and environmental developments: together we create a safe and liveable world.

### BACKGROUND

Marine surveying and/or other geophysical surveying performed in a marine or underwater environment can involve the collection of various types of data that relate to one or more properties of the underwater environment. For example, various geophysical techniques can be used for mapping the seafloor surface, as well as other sub-surface regions and/or layers, etc. Ocean Bottom Node (OBN) seismic surveying is a marine geophysical survey technique that can be used for subsurface imaging in underwater environments, including in deepwater and complex environments, for subsurface exploration and/or reservoir characterization, among others. OBN seismic surveys can be performed using sensor packages that are placed directly on the seafloor to record sensor data corresponding to seismic wave propagation through subsurface geological formations. For example, OBN seismic surveys may use a plurality of sensor nodes (also referred to as “OBN nodes”, or simply “nodes”) to deploy the sensor packages to the seafloor surface. The OBN nodes may be deployed within a field or other surveying area located on the seafloor surface, with the OBN nodes arranged in a pattern or distributed configuration relative to one another. In some examples, OBN nodes may be deployed in an approximate grid pattern or similar configuration across the seafloor survey field. In some examples, the deployment of the OBN nodes may be performed using remote operated vehicles (ROVs) or other underwater platforms.

Each OBN node can implement a seismic sensing and recording system, and can implement various seismic sensing configurations using one or more hydrophones, geophones, etc. The OBN nodes deployed within the survey field can each operate autonomously and/or independently, wherein each respective OBN node is configured to continuously or periodically record seismic sensor data over a period of time corresponding to the OBN seismic survey. For example, OBN nodes may remain on the seabed for days, weeks, months, or longer, based on the parameters of the OBN seismic survey that is to be performed. As noted above, OBN nodes can be deployed in a grid-based or other pattern on the seafloor, with inter-node spacing (e.g., the spacing or distance between neighboring nodes) varying from on the order of tens of meters, hundreds of meters, and/or one or more kilometers.

Based on the autonomous and/or independent operation of the OBN seismic nodes to each record or log respective sensor data for the duration of the survey operation, the accuracy of the OBN seismic survey data obtained from post-processing the respective data collected at each node may depend at least in part on the accuracy of the relative positioning of the OBN seismic nodes with respect to one another. For example, some OBN seismic surveys can be associated with a minimum threshold accuracy requirement on the relative depth measurements between the various nodes included in an array comprising a plurality of OBN seismic nodes deployed on the seafloor. In some cases, increased accuracy of the relative depths between the OBN seismic nodes of a node array can correspond to increased accuracy of the OBN seismic survey data and/or three-dimensional (3D), four-dimensional (4D), etc., analyses performed using the OBN seismic survey data (e.g., such as 3D or 4D reservoir analyses based on the OBN seismic survey data, etc.). For example, obtaining accurate OBN seismic node relative depths can correspond to minimizing error in the static solutions and final seismic images produced for the survey. There is thus a need to address problems associated with providing accurate relative depth between seismic nodes deployed on the seafloor for various surveying operations, for example by providing a solution for relative depth derivation for seismic nodes on the seafloor surface.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some examples, systems and techniques are described for determining relative depth information for each seismic node of a plurality of seismic nodes deployed on a seafloor surface. For example, the plurality of seismic nodes can be a plurality of Ocean Bottom Node (OBN) seismic nodes and/or various other nodes associated with OBN surveying operations for a seafloor environment. In some aspects, the systems and techniques described herein can be implemented for a plurality of seismic nodes comprising a plurality of OBN nodes. In some examples, the plurality of seismic nodes comprises a plurality of non-OBN nodes. In some embodiments, the plurality of seismic nodes can comprise various combinations of one or more OBN nodes (e.g., the plurality of seismic nodes includes a subset of OBN nodes) and one or more non-OBN nodes (e.g., the plurality of seismic nodes additionally can include a subset of non-OBN nodes). In some examples, the relative depth information for the seismic nodes can be determined by a moveable subsea unit, which may be a remote operated vehicle (ROV), an autonomous underwater vehicle (AUV), an uncrewed underwater vessel (UUV), a remote operated towed vehicle (ROTV), a tetherless ROV, etc., among various others. In some aspects, a relative depth can be determined for each seismic node of the plurality of seismic nodes based on the moveable subsea unit performing a non-contact relative depth derivation for each seismic node. The non-contact relative depth derivation can be performed without contact between the moveable subsea unit and the plurality of seismic nodes.

In one illustrative example, a method can include: obtaining, using a camera system attached to a moveable subsea unit, image data of a scene associated with a plurality of seismic nodes deployed on a seafloor surface; analyzing the image data to detect a configured tracking pattern within the scene, wherein the configured tracking pattern is attached to a respective seismic node of the plurality of seismic nodes; determining depth information corresponding to the moveable subsea unit, wherein the depth information is determined based on sensor data obtained from one or more pressure sensors attached to the moveable subsea unit; determining, using the image data, relative positioning information between the camera system and the configured tracking pattern detected within the scene; and combining the depth information and the relative positioning information to determine a derived depth of the respective seismic node deployed on the seafloor surface.

In some aspects, the depth information comprises a pressure-based relative depth estimation corresponding to the moveable subsea unit; the relative positioning information comprises a computer vision-based vertical offset from the moveable subsea unit to the respective seismic node; and the derived depth of the respective seismic node comprises relative depth information for the respective seismic node.

In some aspects, combining the depth information and the relative positioning information includes: obtaining information indicative of an offset between the camera system attached to the moveable subsea unit and the one or more pressure sensors attached to the moveable subsea unit; combining the depth information with the relative positioning information according to the offset; and determining the derived depth of the respective seismic node based on the combining.

In some aspects, the information indicative of the offset is based on one or more of: a fixed geometry between a focal point of the camera system and a reference point of the one or more pressure sensors attached to the moveable subsea unit; pose information associated with the camera system; and pose information associated with the one or more pressure sensors.

In some aspects, the offset between the camera system and the one or more pressure sensors includes a first vertical offset and an angular offset, wherein the angular offset is based on the pose information associated with the camera system and the pose information associated with the one or more pressure sensors; the relative positioning information comprises a second vertical offset between the camera system and the configured tracking pattern, wherein the second vertical offset is determined using the pose information associated with the camera sensor; and the derived depth of the respective seismic node is a sum of the depth information, the first vertical offset, and the second vertical offset.

In some aspects, the relative positioning information includes: a relative distance between the camera system and the configured tracking pattern attached to the respective seismic node, wherein the camera system is configured to estimate the relative distance using the image data of the scene in response to detection of the configured tracking pattern; and orientation information indicative of an angular offset of the camera away from a vertical depth axis.

In some aspects, the method further comprises: correcting the relative distance between the camera system and the configured tracking pattern based on the orientation information, to thereby generate corrected relative distance information, wherein the corrected relative distance information is aligned with the vertical depth axis; and combining the depth information and the corrected relative distance information to determine the derived depth of the respective seismic node deployed on the seafloor surface.

In some aspects, the corrected relative distance information comprises a vertical offset between the camera system and the respective seismic node along the vertical depth axis.

In some aspects, determining the relative positioning information includes determining an attitude of the camera system, the attitude determined corresponding to a time of capture of the image data by the camera system.

In some aspects, the attitude of the camera system is determined based on additional sensor data obtained from one or more Motion Reference Units (MRUs) included in the moveable subsea unit.

In some aspects, the depth information corresponding to the moveable subsea unit is determined relative to a configured reference depth; and the derived depth of the respective seismic node is determined relative to the same configured reference depth.

In some aspects, the configured reference depth is based on a pressure measurement obtained corresponding to a subsea benchmark structure having the configured reference depth.

In some aspects, the derived depth of the respective seismic node comprises a relative depth referenced to the configured reference depth based on the depth information.

In some aspects, the method further includes: taring the one or more pressure sensors attached to the moveable subsea unit, the taring performed based on a measurement of the configured reference depth; and determining the depth information corresponding to the moveable subsea unit based on sensor data obtained from the one or more pressure sensors after taring the one or more pressure sensors.

In some aspects, the moveable subsea unit comprises a remote operate vehicle (ROV) deployed within a water column above the seafloor surface.

In some aspects, the method further includes: determining a respective derived depth for each seismic node of the plurality of seismic nodes deployed on the seafloor surface, wherein the respective derived depth for each seismic node is determined using a pressure-based depth estimate obtained from the one or more pressure sensors and a computer vision-based depth estimate obtained from image data of a corresponding tracking pattern attached to each seismic node.

In some aspects, the respective derived depth for each seismic node of the plurality of seismic nodes is referenced to a same configured reference depth.

In some aspects, the method further includes: processing the image data obtained for each seismic node of the plurality of seismic nodes to generate point-cloud imagery corresponding to one or more of: at least a subset of the plurality of seismic nodes, or a survey field comprising the plurality of seismic nodes deployed on the seafloor surface.

In some aspects, the method further includes: obtaining time-series data indicative of one or more tidal variations associated with a seafloor area corresponding to the plurality of seismic nodes; generating refined pressure data measurements based on using the time-series data to perform tidal compensation of the sensor data obtained from the one or more pressure sensors; and determining the depth information corresponding to the moveable subsea unit based on the refined pressure data measurements.

In another illustrative example, a system for determining relative depths of seismic nodes is provided, the system comprising: a moveable subsea unit; a camera system attached to the moveable subsea unit at a first attachment location; one or more pressure sensors attached to the moveable subsea unit and associated with a second attachment location, wherein the second attachment location is a reference location for the one or more pressure sensors; at least one processor; and a memory storing instructions which when executed by the at least one processor, causes the at least one processor to: obtain, using the camera system, image data of a scene associated with a plurality of seismic nodes deployed on a seafloor surface; analyze the image data to detect a configured tracking pattern within the scene, wherein the configured tracking pattern is attached to a respective seismic node of the plurality of seismic nodes; determine depth information corresponding to the moveable subsea unit, wherein the depth information is determined based on sensor data obtained from the one or more pressure sensors; determine, using the image data, relative positioning information between the camera system and the configured tracking pattern detected within the scene; and combine the depth information and the relative positioning information to determine a derived depth of the respective seismic node deployed on the seafloor surface.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIGS. 1A and 1B illustrate example views of a seismic node that may be deployed to a seafloor surface for one or more node-based marine surveying operations, in accordance with some examples;

FIG. 2 is an example of a frame of image data depicting a seismic node deployed on a seafloor surface and with a configured tracking pattern attached to a surface of the seismic node, in accordance with some examples;

FIG. 3 is a diagram illustrating an example of a moveable undersea unit and a plurality of seismic nodes deployed to a seafloor surface with each respective seismic node of the plurality of seismic nodes having a respective vertical offset from a reference depth, in accordance with some examples;

FIG. 4 is a top-view schematic diagram illustrating an example of a plurality of seismic nodes deployed within a seafloor survey field, where the seafloor survey field and the plurality of nodes include and/or are associated with one or more reference structures and/or water level recorders (WLRs), in accordance with some examples;

FIG. 5 is a diagram illustrating an example of a moveable subsea unit including a camera system, one or more pressure sensors, and a motion reference unit (MRU) that can be used to determine a derived depth of a seismic node deployed on the seafloor surface, in accordance with some examples;

FIG. 6 is a flow diagram illustrating an example of a process for determining derived relative depth information for a seismic node, in accordance with some examples;

FIG. 7 is a flow diagram illustrating an example of a process for determining relative depth information for seismic nodes deployed on a seafloor surface, in accordance with some examples; and

FIG. 8 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Systems and techniques are described herein for determining relative depths of respective seismic nodes included in a plurality of seismic nodes deployed to a seafloor surface (e.g., such as seismic nodes and/or various other nodes associated with a marine surveying operation, etc.). In some examples, a seismic node may be an Ocean Bottom Node (OBN) used to perform an OBN or OBN-based seismic survey, etc., for a corresponding region of the seafloor surface to which the plurality of seismic nodes are deployed. In some aspects, deployment and/or retrieval of the seismic nodes, to and from the seafloor, can be performed using one or more moveable subsea units. For example, deployment and/or retrieval of the seismic nodes may be performed using an ROV, AUV, UUV, ROTV, etc.

In one illustrative example, the systems and techniques described herein can be used to provide relative depth determination for each seismic node, based on combining pressure sensor data and image data obtained by respective pressure sensors and camera system(s) implemented by the ROV or other moveable subsea unit that performs the deployment and/or retrieval of the subsea nodes. The relative depth determination for each seismic node can be performed to reference each seismic node to the same reference depth, where the ROV or moveable subsea unit performs a separate relative depth determination process for each of the seismic nodes in a set of multiple seismic nodes while repeatedly using the same reference depth during each relative depth derivation. For example, the systems and techniques can be used to determine relative depth information, rather than absolute depth information, for the plurality of seismic nodes deployed within a seafloor survey area or field. By determining relative, rather than absolute depth, the sensor data obtained and logged by the individual seismic nodes during the survey time period can be better correlated, cross-referenced, and/or otherwise post-processed for analysis and visualization of the sub-surface regions, layers, characteristics, etc. in the surveyed area.

In some embodiments, the separate relative depth determination performed for each seismic node can be a relative depth determination that is referenced to (e.g., derived relative to) a single, consistent depth reference across each of the individual relative depth derivations. For example, the systems and techniques can be used to determine relative depths of the seismic nodes as vertical offsets from a single reference depth, which may be a reference depth associated with the survey field or survey area, may be a reference depth associated with a physical reference frame or other reference structure or apparatus located within or nearby to the survey field or seafloor area, etc. The relative depth of each seismic node can be derived as a relative depth referenced to an intermediate underwater depth corresponding to the reference frame or other structure that provides the depth reference information.

Various aspects of the present disclosure will be described below with respect to the figures.

As noted above, Ocean Bottom Node (OBN) and/or OBN-based seismic surveying is a type of marine geophysical surveying technique that can be used for subsurface imaging in underwater environments, such as for subsurface exploration and/or reservoir characterization, among various others. OBN surveys are also referred to herein as seismic surveys, and vice versa. To perform an OBN survey, a plurality of self-contained sensing and recording devices are placed directly on the seafloor to record seismic signals. The sensor data is logged (e.g., recorded) autonomously and in a self-contained manner at each recording device, over a time duration generally corresponding to a configured or desired duration of the OBN survey. As also noted previously, these self-contained sensing and recording devices placed on the seafloor for performing an OBN survey may also be referred to as “OBN nodes” and/or “seismic nodes.”

An OBN node can comprise or include a seismic sensor array with one or more sensors configured to passively (and/or actively) measure and record seismic signals over extended periods of time. For example, OBN nodes can include a seismic sensor array including one or more of a geophone, a hydrophone, a pressure sensor, etc. OBN nodes may further include an internal battery or other power supply source, a storage component for logging and storing the collected seismic sensor data onboard the OBN node during the survey, a ruggedized housing to withstand the underwater conditions during deployment and operation of the OBN node on the seafloor surface, etc. After deployment, and during the course of an OBN survey, the OBN nodes remain stationary on the seabed, and can collect seismic sensor data that may be referenced to an accurate location of the OBN node (e.g., the location to which the OBN node was deployed to at the start of the survey operations, in this case with the assumption of minimal to no post-deployment movement or physical location drift of the OBN node during the course of the surveying operations, etc.). By referencing the collected seismic sensor data to the location of the OBN node, and referencing the location of each respective OBN node to the relative location(s) of additional OBN nodes deployed in the same survey field for the same survey operation(s), an accurate three-dimensional understanding can be obtained from the survey data, representing the geophysical conditions in a three-dimensional coordinate space, etc. By synchronizing time data associated with the seismic sensor data logged at the respective OBN nodes, a “four-dimensional” (4D) survey data can be obtained, where changes over time are added to represent a fourth-dimension for the 3D coordinate space survey data. In some aspects, the self-contained and stationary deployment of the plurality of OBN nodes (e.g., also referred to as “seismic nodes,” and vice versa), and/or the logging of accurately localized seismic sensor data over time, can be used to obtain high-fidelity seismic survey data that may have a better signal-to-noise ratio (SNR) and less interference from water column effects than in techniques such as towed streamer seismic surveying, etc.

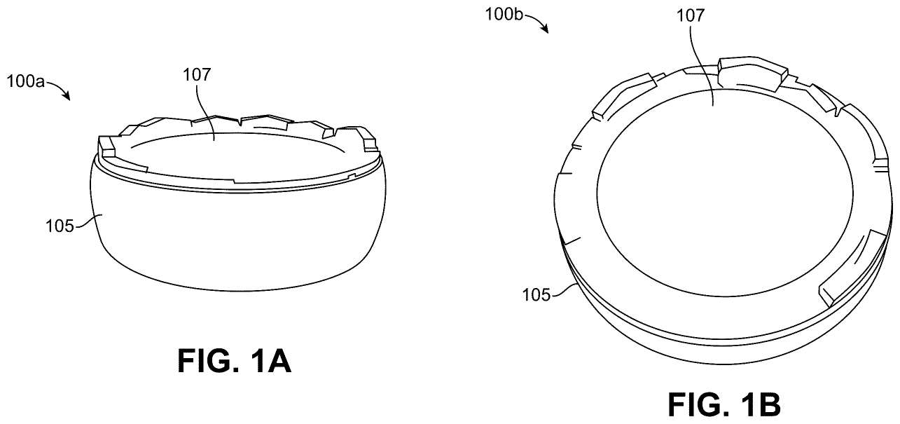

Example views of a seismic node are depicted in FIGS. 1A and 1B, which illustrate the seismic node as being cylindrical in shape (e.g., circular in cross-section), although it is noted that various other seismic node sizes, dimensions, configurations, etc., may also be utilized without departing from the scope of the present disclosure. In particular, FIG. 1A illustrates a side perspective view 100a of a seismic node 105 that may be deployed to a seafloor surface for performing a node-based marine surveying operation such as an OBN and/or seismic survey, etc. FIG. 1B illustrates a top perspective view of the same example seismic node 105, where the example seismic node 105 includes an upper surface 107 located on a housing or other exterior surface of the seismic node 105.

In the examples of FIG. 1A and FIG. 1B, the upper surface 107 of the seismic node 105 is provided as a flat, circular surface that is located away from the seafloor surface during deployment of the seismic node 105 (e.g., the opposite cylindrical surface, below the upper surface 107, may be the portion of the seismic node 105 that makes contact with and/or is embedded or partially embedded into the seafloor surface by the deployment of the seismic node 105 for the OBN survey operations, etc.). Various other upper surface geometries, shapes, profiles, etc., may also be implemented by or for the example seismic node 105 without departing from the scope of the present disclosure.

In some examples, OBN surveys may be performed based on deploying a plurality of OBN nodes (e.g., seismic nodes, such as seismic node 105, etc.) in a grid or other pattern within a survey field comprising a region or area of seafloor surface that is the subject of the survey. The plurality of OBN nodes can be respective nodes having the same or similar design and configuration. For example, an OBN survey can be performed based on deploying a plurality of OBN nodes that are each the same as, or similar to, the example seismic node 105 of FIGS. 1A and 1B, etc. In some cases, OBN surveys using seismic node(s) 105 may be performed for deepwater environments, among other areas with complex subsurface geology.

In further examples, OBN surveys using seismic node(s) 105 may be performed in examples where other techniques, such as towed-streamer seismic surveys, etc., are impractical, less effective, more complex and challenging to perform, more cost intensive, etc. In some cases, OBN seismic surveys can use the seismic nodes 105 deployed in a grid or other pattern on the seafloor surface of the survey field to capture three-dimensional data (e.g., (x, y, z)-dimensioned data) of the survey field, with the 3D information correlated with the sensor data according to an accurate determination of the respective 3D location or position of each seismic node 105 deployed on the seafloor surface. In some cases, the 3D location or position information of the seismic nodes 105 may be obtained as absolute location information. In some examples, the 3D location or position information of the seismic nodes 105 can be obtained or calculated as relative location information, for example reference to a common or configured reference point, reference depth, etc.

In some examples, OBN surveys can be performed based on deploying a plurality of OBN seismic nodes (e.g., such as the OBN seismic node(s) 105, etc.) in a configured pattern on or about the seafloor surface corresponding to a survey field or survey area. The plurality of OBN seismic nodes 105 may be deployed from a survey vessel to a respective location of each node on the seafloor surface. In some examples, the survey vessel may be a surface vessel or ship, which may be configured to deploy the OBN seismic nodes using a free-fall deployment system, among various other deployment systems and techniques. In some cases, the survey vessel can be an underwater (e.g., sub-surface, etc.) vessel that deploys the OBN seismic nodes 105 at a closer distance (e.g., smaller vertical separation) from the underwater survey vessel to the seafloor surface. For instance, in one illustrative example, the OBN seismic nodes 105 can be deployed from an underwater vessel such as an ROV (including tethered and/or tetherless ROV implementations, etc.), an AUV, UUV, etc.

In some examples of OBN seismic node deployment, a moveable subsea unit (e.g., ROV, etc.) can be used to precisely position each node according to a deployment pattern or deployment configuration for arranging the plurality of OBN seismic nodes on the seafloor surface within the survey area. In some cases, ROVs or other moveable subsea units can be used for OBN seismic node deployment operations for OBN surveys in deepwater environments (e.g., depths of 1,000 meters or more), although it is noted that ROV deployment of OBN seismic nodes may also be utilized at various other depths within the context of the present disclosure.

In some cases, OBN seismic nodes can be both deployed and retrieved from the seafloor surface by an ROV or other subsea moveable unit. The deployment of the OBN seismic nodes can be performed corresponding to initiating an OBN survey, and the retrieval of the OBN seismic nodes can be performed corresponding to the conclusion or termination of the OBN survey. For example, as noted above, the individual OBN nodes once deployed can operate as autonomous and self-contained seismic sensor array units, with the respective seismic sensor data measured at each node logged and stored to an onboard memory of the node during the course of the survey duration. Once the survey duration or survey time period is complete, the ROB or subsea moveable unit can be used to perform retrieval of the seismic nodes from the seafloor surface for later data extraction, analysis, and/or post-processing, etc., to obtain the aggregated OBN survey data (which may be 3D and/or 4D survey data) based on jointly processing the locally logged seismic sensor data obtained from each respective seismic node of the plurality of deployed and retrieved seismic nodes.

To perform the joint or combined processing of the respective seismic sensor data logged and stored by individual seismic nodes, OBN surveys may be performed to include a relative depth determination for each seismic node of the plurality of seismic nodes that are deployed to the survey field seafloor area. For example, the topography of the seafloor can vary over different locations within the survey field seafloor area within which the seismic nodes are deployed. Accordingly, different nodes may be deployed to different depths, and may log seismic sensor data with variations in seismic wave arrivals, both temporally and spatially, based at least in part on the particular depth or location where the seismic node is deployed on the seafloor surface. Depending on the seafloor topography, relative node depth variations may also introduce distortions, reflections, phase errors, etc., in the collected seismic data, the correction of which may correspond to post-processing that utilizes as input the relative depth and/or location information of the respective nodes for which the correction is being performed. In other examples, the relative positioning and depth of the respective seismic nodes deployed within the survey field seafloor area may be needed at a relatively high accuracy in order to obtain multi-component seismic information during the post-processing of the aggregated seismic node sensor data collected during an OBN survey. Accordingly, it can be beneficial to obtain or otherwise determine accurate relative depth and/or relative position information for the respective OBN seismic nodes of a plurality of a OBN seismic nodes deployed to an area of seafloor surface corresponding to an OBN or other subsea seismic surveying operation.

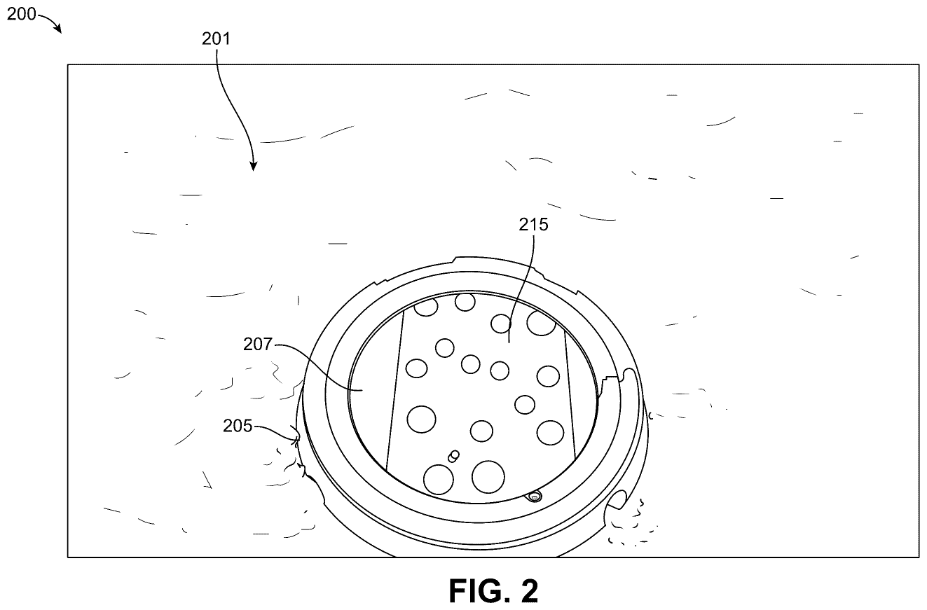

FIG. 2 illustrates an example of a seismic node 205 deployed on a seafloor surface 201, where a lower face (e.g., lower surface) of the seismic node 205 is in contact with the seafloor surface 201 after deployment of the seismic node 205, and an upper face (e.g., upper surface) 207 of the seismic node 205 is located away from the seafloor surface 201. In some aspects, the upper face or surface 207 of the seismic node 205 can be unobstructed by the seafloor surface 201 in the deployed configuration and position of the seismic node 205. In some aspects, the seismic node 205 of FIG. 2 may be the same as or similar to the seismic node 105 of FIGS. 1A and 1B. In some examples, the upper face/surface 207 of the seismic node 205 of FIG. 2 can be the same as or similar to the upper face/surface 107 of the seismic node 105 of FIGS. 1A and 1B, etc.

In some embodiments, the upper face/surface 207 of the seismic node 205 can include and/or can be attached to a tracking pattern 215 that is configured for use with computer vision and/or other visual recognition and/or object detection systems that can use image data of scenes of the seafloor surface within the deployment area (e.g., survey field) corresponding to the seismic node 205 to perform detection of the configured tracking pattern 215. Based on the configured tracking pattern 215 being registered with the visual recognition system, the configured tracking pattern 215 can be detected in one or more image data captures of the seafloor surface scene. Based on the configured tracking pattern 215 being attached to, integrated with, combined with, coupled to, etc., the upper face/surface 207 of the seismic node 205, the detection of the configured tracking pattern 215 by the visual recognition system can be used as a detection of the corresponding seismic node 205 to which the configured tracking pattern 215 is attached.

In some cases, the configured tracking pattern 215 can be integrated with or integrally formed with the upper face/surface 207 of the seismic node 205. For example, the tracking pattern can be printed directly onto the upper face/surface 207, can be integrally formed from a contrasting color and/or material from a remaining portion of the upper face/surface 207 at the time of manufacture, etc. In some examples, the configured tracking pattern 215 can be a separate physical component upon which the tracking pattern 215 is provided, where the separate physical component with the tracking pattern 215 is subsequently attached, coupled, bonded, mounted, etc., upon the upper face/surface 207 of the seismic node 205.

In one illustrative example, FIG. 2 illustrates a frame of image data 200 that depicts the seismic node 205 with the attached tracking pattern 215, deployed on the seafloor surface 201. For example, the frame of image data 200 can be an image of a scene of the seafloor surface corresponding to or depicting at least a portion of an OBN survey area (e.g., also referred to as a deployment area, or an area of the seafloor surface where the plurality of seismic nodes 205 are deployed to respective locations for performing the OBN survey operations, etc. The frame of image data 200 can be a frame of image data captured using an underwater camera, for example such as a camera image data from, a camera unit disposed on a subsea platform (e.g., also referred to as a subsea unit, and/or a moveable subsea unit, etc.) such as an ROV, UUV, AUV, etc., among various others.

In one illustrative example, the frame of image data 200 includes a representation of at least a portion of the seismic node 205 deployed onto the seafloor surface 201, and further includes a representation of the configured tracking pattern 215 attached to the upper face/surface 207 of the seismic node 205. Based on the representation or depiction of the configured tracking pattern 215 within the frame of image data 200, detection and recognition can be performed to determine relative location and/or positioning information of the tracking pattern 215, for example relative to a reference point or focal center of a camera or camera system that was used to capture the frame of image data 200. In some aspects, the camera or camera system used to capture the frame of image data 200 can be included in and/or implemented by the computer vision and/or other visual recognition and/or object detection systems noted above as configured for use in detecting and recognizing the configured tracking pattern 215. In some aspects, the frame of image data 200 can be obtained by a camera included in a pattern detection and/or recognition camera system of a moveable subsea unit (e.g., ROV, UUV, AUV, etc.) that is associated with the OBN surveying operations and/or that is associated with the OBN seismic node 205. For example, the frame of image data 200 can be obtained by a camera of a pattern detection and recognition camera system attached to an ROV or other moveable subsea unit that is used to deploy and/or retrieve the OBN seismic nodes 205 to and from the seafloor surface at the start and end (respectively) of a respective OBN surveying operation.

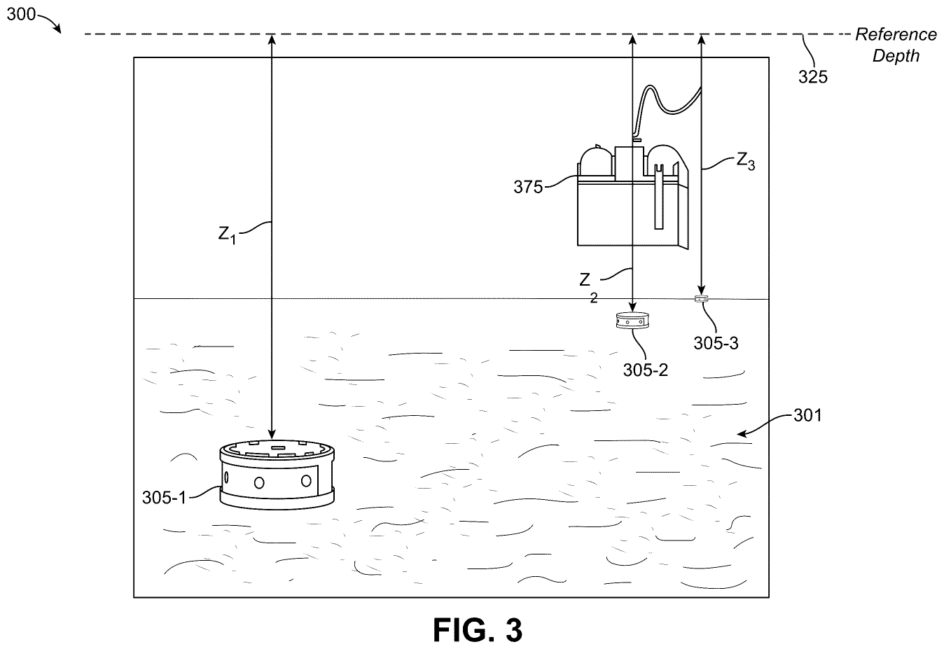

FIG. 3 is a diagram illustrating an example of an underwater survey field 300 corresponding to a portion of seafloor surface 301 upon which a plurality of seismic nodes (e.g., OBN nodes) 305-1, 305-2, 305-3, . . . , etc., are deployed to respective locations on the seafloor surface 301. For example, the seismic nodes 305-1, 305-2, 305-3, . . . , etc., can be deployed to their respective locations on the seafloor surface 301 by a moveable subsea unit 375, which in some embodiments may be an ROV, AUV, UUV, etc. The moveable subsea unit 375 can be associated with and used for deploying each respective seismic node 305-1, 305-2, 305-3 to the respective seafloor surface 301 deployment location for the node. The moveable subsea unit 375 may additionally, or alternatively, be used for retrieval of the respective seismic nodes 305-1, 305-2, 305-3 from the deployment locations on the seafloor surface 301, where retrieval of the seismic nodes is performed corresponding to the completion or termination of an OBN surveying operation using the seismic sensor data logged by the seismic nodes 305-1, 305-2, 305-3 while previously deployed in-situ onto the seafloor surface 301.

In some examples, one or more (or all) of the plurality of seismic nodes 305-1, 305-2, 305-3, . . . , etc., can be the same as or similar to one another. In some embodiments, one or more (or all) of the plurality of seismic nodes 305-1, 305-2, 305-3, . . . , etc. may be the same as or similar to the seismic node 105 of FIGS. 1A and 1B, the seismic node 205 of FIG. 2, etc. The respective location of each seismic node 305-1, 305-2, 305-3 can be according to a configured deployment pattern or deployment configuration for arranging the plurality of seismic nodes in a grid or other pattern distributed across the seafloor surface 301 within the survey area. In one illustrative example, the respective seismic nodes 305-1, 305-2, 305-3 can be deployed to different respective locations on the seafloor surface 301, where the respective location of a seismic node 305-1, 305-2, 305-3, . . . , etc. includes a corresponding depth of each seismic node. For example, the corresponding depth of each seismic node 305-1, 305-2, 305-3 may be represented as an absolute depth, and/or can be represented as a relative depth.

In one illustrative example, each seismic node 305-1, 305-2, 305-3 can be associated with a corresponding relative depth, where the relative depth for each seismic node 305-1, 305-2, 305-3 is a relative depth referenced to a configured reference depth 325. For example, as illustrated in the example of FIG. 3, the first seismic node 305-1 is associated with a relative depth z₁, representing the relative depth (e.g., vertical offset) between the first seismic node 305-1 and the reference depth 325. The second seismic node 305-2 is associated with a relative depth z₂, representing the relative depth (e.g., vertical offset) between the second seismic node 305-2 and the same reference depth 325. The third seismic node 305-3 is associated with a relative depth z₃, representing the relative depth (e.g., vertical offset) between the third seismic node 305-3 and the same reference depth 325.

In some aspects, the reference depth 325 can be a configured reference depth associated with one or more of the OBN survey, the survey field 300 within which the OBN survey is performed and the plurality of seismic nodes 305-1, 305-2, 305-3, etc., are deployed, and/or various other underwater or subsea depth reference apparatuses. For example, the configured reference depth 325 can be obtained as a reference depth corresponding to a physical depth benchmark located within or nearby to the survey field 300 of the OBN survey. In examples where the seismic nodes 305-1, 305-2, 305-3 are used to perform an OBN survey for an existing reservoir or sub-sea formation, an existing depth benchmark apparatus and reference depth 325 may be available. For example, the depth benchmark may be provided by a reference frame on the seafloor with one or more depth sensor attached thereto. The depth of the reference frame (which in some cases can be the derived depth of the reference frame, according to the pressure sensor data obtained by the pressure sensors on the benchmark depth reference frame) can be used as the configured reference depth 325 for deriving the relative depth information for the plurality of seismic nodes 305-1, 305-2, 305-3 deployed for the OBN survey operations. In some cases, the existence of a benchmark or reference depth frame, apparatus, etc., for providing the reference depth 325 can further correspond to a reference coordinate system that is configured relative to the depth benchmark. For example, the reference depth 325 can be a configured reference depth associated with, provided by, measured by, etc., one or more benchmark depth reference frames in the area of the OBN survey, where the reference depth 325 is further associated with a reference coordinate system having its origin at the location of the benchmark depth reference frame.

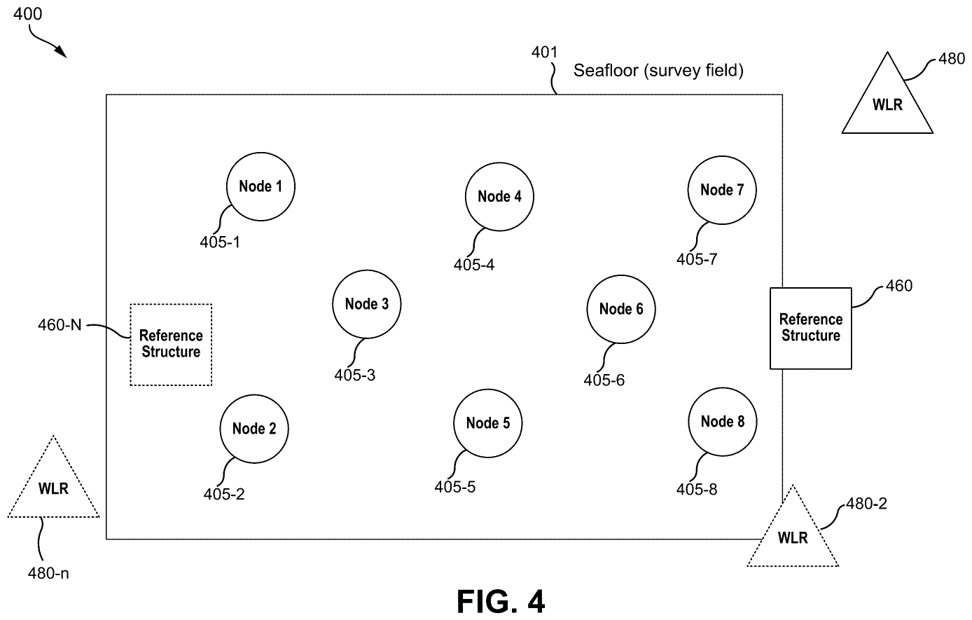

For example, FIG. 4 is a top-view schematic diagram of a seafloor deployment 400, illustrating an example of a plurality of seismic nodes (e.g., 405-1, 405-2, 405-3, 405-4, 405-5, 405-6, 405-7, 405-8, . . . , etc., collectively referred to as the “seismic nodes 405”) that are deployed to respective locations within a survey field on the seafloor 401. In some embodiments, the seafloor survey field 401 and the plurality of seismic nodes 401 are associated with one or more reference structures, which may be benchmark depth references (e.g., benchmark depth reference frames or other physical apparatuses used to provide the configured depth reference 325 of FIG. 3, etc.). The benchmark depth reference structure(s) may be located within the seafloor survey field 401, such as the reference structure 460-N illustrated in FIG. 4 as included within the perimeter of the seafloor survey field area 401. In some examples, the benchmark depth reference structure(s) may comprise one of the plurality of seismic nodes 405. In other examples, the benchmark depth reference structure(s) 460-N, etc., are separate and different from the plurality of seismic nodes 405. In some embodiments, a benchmark depth reference structure(s) may be located adjacent to, nearby to, outside of, etc., the seafloor survey field area 401, such as the reference structure 460 shown in the example of FIG. 4. The configured reference depth 325 of FIG. 3 can be provided by one or more, or both, of a benchmark depth reference structure 460-N that is within the seafloor survey field 401, and/or a benchmark depth reference structure 460 that is located outside of (e.g., not within) the seafloor survey field 401.

The seafloor deployment 400 associated with the seafloor survey field 401 and the plurality of seismic nodes 405 deployed for the OBN survey operations (e.g., deployed by the ROV/moveable subsea unit 375 of FIG. 3, etc.) can further include one or more water level recorders (WLRs), such as the WLR 480 (e.g., located outside of, but adjacent/nearby to the seafloor survey field 401), the WLR 480-2 (e.g., located on the perimeter or boundary of the seafloor survey field 401), and/or the WLR 480-n (e.g., located outside of, but adjacent/nearby to the seafloor survey field 401, on an opposite side of the seafloor survey field 401 form the first WLR 480), etc. The one or more WLRs (e.g., one or more of WLRs 480, 480-2, 480-n, . . . , etc.) may be existing infrastructure associated with the survey field or sub-sea reservoir, etc. The one or more WLRs may be provided by the same entity as the one or more depth reference benchmark structures 460, 460-N, etc. For example, the depth reference benchmark structures 460, 460-N, etc., and the one or more WLRs 460, 460-2, 460-n, etc., may be provided by an owner, operator, etc., or other entity associated with the seafloor survey field 401. In some cases, the entity associated with the depth reference benchmark structures 460, 460-N, etc., and the one or more WLRs 460, 460-2, 460-n, etc., may be a client, consumer, user, receiver, etc., of the OBN survey data that is obtained based on performing the OBN survey using the plurality of seismic nodes 405 deployed onto the seafloor surface within the seafloor survey field 401, etc.

The one or more WLRs 480, 480-2, 480-n, etc., can be used for measuring tidal variations or tidal effects that may cause fluctuations in one or more depth and/or pressure measurements obtained by sensors within or nearby to the seafloor survey field 401. For example, tidal variations can correspond to the cyclical increase or decrease in the depth of the water column above the seafloor survey field 401. The tidal variation corresponding to increased water column depth above the seafloor survey field 401 can cause increased pressure sensor readings by the plurality of seismic nodes 405-1, the depth benchmark reference structures 460, 460-N. Increased pressure sensor readings correspond to increased derived depth values that are calculated based on the tidally-influenced increased pressure sensor readings. Similarly, the tidal variation corresponding to decreased water column depth above the seafloor survey field 401 can cause decreased pressure sensor readings by the plurality of seismic nodes 405-1, the depth benchmark reference structures 460, 460-N. The decreased pressure sensor readings correspond to decreased derived depth values that are calculated based on the tidally-influenced decreased pressure sensor readings.

The tidal variation in the water column depth/height above the seafloor survey field 401 corresponds to variation or fluctuation in the pressure sensor readings and the derived depth values calculated from the pressure sensor readings. The accuracy of the seismic sensor data logged and recorded at each of the plurality of seismic nodes 405, along with the accuracy of the resulting processed OBN survey data obtained from the aggregation and post-processing of the aggregated OBN survey data form the plurality of seismic nodes 405, can be impacted by the tidal variations, if not removed or compensated. For example, the derived depth measurements at the various seismic nodes 405 or benchmark depth reference structures 460, 460-N will show changing depth according to the cyclical tidal variation, while in reality the true depth and location of the seismic nodes 405 and benchmark depth reference structures 460, 460-N has not changed as would be indicated by the un-compensated pressure sensor and derived depth data that includes the cyclical tidal variation effects.

Accordingly, the one or more WLRs 480, 480-2, 480-n can be located within and/or nearby to the seafloor survey field 401, and can be used to measure the cyclical tidal variations experienced by all of the pressure sensors within the seafloor survey field 401. For example, the one or more WLRs 480, 480-2, 480-n can include respective pressure sensors, among various other sensors, that measure the same effect from the tidal variation as is experienced by the seismic nodes 405 and benchmark depth structures 460, 460-N for which the tidal compensation will be applied. In some aspects, the tidal compensation can be implemented by using the WLRs 480, 480-2, 480-n and/or various other reference sensors such as tide gauges, etc., to measure the tidal variation effect experienced over the entire seafloor survey field 401, and subsequently subtracting the measured tidal variation(s) over the duration of the survey period from the respective pressure sensor and/or derived depth measurements obtained at each seismic node 405 and benchmark depth reference structure 460, 460-N.

In some examples, the tidal variation data can be obtained from pressure sensors and/or corresponding derived depth values calculated from the pressure sensors at the benchmark depth reference frame(s) 460, 460-N. For example, the tidal variation can be measured as the cyclical pressure changes at the benchmark depth reference frame(s) 460, 460-N as the increasing or decreasing water column height due to the tide cycle causes the measured pressure at the (static and non-moving) benchmark depth reference frame 460, 460-N to fluctuate. In some aspects, tidal variation data and subsequent tidal compensation for the seismic nodes 405 can be implemented using a combination of tidal variation data obtained from the benchmark depth reference frames 460, 460-N and the WLRs 480, 480-2, 480-n. In some examples, tidal variation data and tidal compensation can be implemented based on tide data originating from client-supplied tide stations permanently installed in close proximity to (e.g., nearby to the boundary of) the seafloor survey field 401, etc.

In one illustrative example, the systems and techniques described herein can be configured to provide relative depth determinations for a plurality of seismic nodes (e.g., the plurality of seismic nodes 405, etc.) deployed on the seafloor surface, where the relative depth determination for a respective seismic node is performed by an ROV or other moveable subsea unit (e.g., such as the ROV or moveable subsea unit 375 of FIG. 3, etc.) used to perform deployment and/or retrieval of the seismic node to and/or from (respectively) the seafloor. In some examples, the relative depth determination can be performed by the ROV or other moveable subsea unit at one or more times or instances that are between the deployment of the seismic node to the seafloor surface, and the retrieval of the seismic node from the seafloor surface. For example, the relative depth determination may additionally, or alternatively, be performed by the ROV or other moveable subsea unit while the seismic node is in-situ on the seafloor surface during an OBN survey (e.g., relative depth determinations can be performed for a deployed seismic node during the OBN survey, etc.).

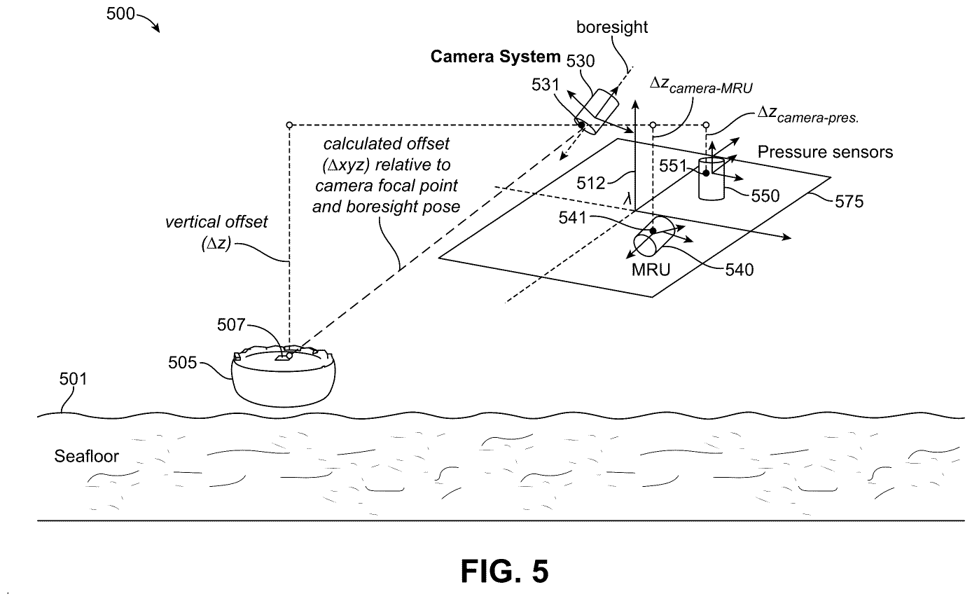

For example, FIG. 5 is a diagram illustrating of an underwater environment 500 associated with an OBN survey using a plurality of seismic nodes deployed to the seafloor surface 501, in accordance with some examples. Illustrated is a respective seismic node 505 deployed on the seafloor surface 501, where the seismic node 505 is one of a plurality of seismic nodes deployed to the seafloor surface 501 in a configured pattern for OBN surveying operations. The seismic node 505 can be the same as or similar to one or more of the seismic node 105 of FIGS. 1A and 1B, the seismic node 205 of FIG. 2, the seismic node 305-1, 305-2, 305-3, etc., of FIG. 3, the seismic nodes 405 of FIG. 4, etc. The seismic node 505 includes an upper face/surface 507, which may be the same as or similar to the upper face/surface 107 of the seismic node 105 of FIGS. 1A and 1B, the upper face/surface 207 of the seismic node 205 of FIG. 2, the upper face/surface of the seismic nodes 305-1, 305-2, 305-3 of FIG. 3, the upper face/surface of the plurality of seismic nodes 405 of FIG. 4, etc.

A configured tracking pattern (not shown in the example of FIG. 5) can be attached to the upper face surface 507 of the seismic node 505, for detection by a camera system 530 of an ROV or moveable subsea unit represented in the example of FIG. 5 as the coordinate frame 575. In some aspects, the ROV or moveable subsea unit 575 of FIG. 5 can be the same as or similar to the ROV or moveable subsea unit 375 of FIG. 3. The camera system 530 can include one or more cameras configured to capture image data and detect the configured tracking pattern(s) on the seismic nodes 505 within the captured image data, as will be described in greater depth below.

In some examples, the moveable subsea unit 575 is an ROV including the pattern recognition camera system 530, one or more pressure sensors included in a pressure sensor array 550, and one or more motion reference units (MRUs) 540 that can be used to determine orientation, pose, and/or attitude angular information corresponding to the orientation of the ROV 575 (e.g., based on a rigid coupling or attachment of the MRU 540 to the housing or chassis of the ROV 575). In some examples, the pattern recognition camera system 530 can be used to obtain the frame of image data 200 shown in the example of FIG. 2, where the pattern recognition camera system 530 uses the one or more cameras attached to the ROV 575 to capture downward-facing images corresponding to scenes of the seafloor 501. In some embodiments, the ROV 575 can use the pattern recognition camera system 530, the pressure sensor array 550, and the MRU 540 to determine a derived depth of the seismic node 505 deployed on the seafloor surface 501, in accordance with some examples.

In some aspects, the moveable subsea unit 575 (e.g., ROV, etc.) includes a pattern recognition camera system 530 configured to capture frames of image data and detect one or more configured patterns within particular frames of the captured image data, where the configured pattern is a pattern that is registered with the pattern recognition camera system 530 and that is attached to an upper face or surface of a respective seismic node 505 deployed onto the seafloor 501. In some cases, the configured pattern (e.g., pattern 215 of FIG. 2, etc.) can be unique for each respective seismic node 505 of a plurality of seismic nodes 505 deployed to the seafloor 501. For example, each seismic node 505 may have a unique, configured pattern 215 attached to the top face/surface of the respective seismic node. In other examples, the configured pattern 215 can be reused for one or more, or all, of the plurality of seismic nodes 505 deployed on the seafloor surface 501 for the OBN survey operations. For example, the deployment pattern of the seismic nodes 505 onto the seafloor 501 can have an inter-node spacing (e.g., distance between adjacent nodes) that is sufficiently large such that the field-of-view (FOV) of the image frames captured by the pattern detection camera system 530 will not include more than one seismic node 505 in any given image frame, and therefore will not include more than one instance of the configured pattern 215 in any given image frame. In some embodiments, the mapping between different seismic nodes 505 (e.g., uniquely identified by a node ID, etc.) and the respective, configured pattern 215 attached to the top face/surface of each seismic node 505 can be stored as mapping information available to the pattern detection camera system 530. Detection of the configured pattern 215 in a captured frame of image data can include identifying the particular configured pattern or pattern type, and matching the identified pattern type to a unique seismic node 505 identifier based on the mapping information (and/or based on comparing a location of the ROV 575 at the time of image capture, to a deployment plan or pattern of the unique seismic nodes 505, where the unique seismic node 505 is determined as the particular seismic node indicated in the deployment plan/pattern at a location that is nearest to the current measured location of the ROV 575 at the time of image capture, etc.).

The pattern detection camera system 530 can be configured to detect the configured pattern 215 on the seismic node(s) 505 using captured imaged frames, rather than streaming video. In some examples, the pattern detection camera system 530 can detect the configured pattern 215 on the seismic node(s) 505 using various combinations of still captured image frames and streaming video (e.g., a plurality of image frames captured at a video frame rate, with the video frame rate in units of frames per second corresponding to the number of still image frames captured and analyzed per second, etc.). In some aspects, the pattern detection camera system 530 can be attached to the ROV 575 at a first location. In some cases, a reference location associated with the camera system 530 can be the point of attachment between the camera system 530 and the ROV 575. In other examples, a reference location associated with the camera system 530 can be different from the attachment point between the camera system 530 and the ROV 575. For example, the reference location for the camera system 530 may be the focal center of the image sensor or camera included in the camera system 5630 and used to capture the frames of image data for performing the pattern detection, etc. In some embodiments, the camera system 530 can be installed upon (e.g., attached to) the ROV 575, and a calibration process may be performed for the camera system 530 to remove or compensate for viewing port distortions in the frames of image data captured by the camera system 530.

The camera system 530 may include one or multiple cameras and/or other image sensors. For example, the frames of image data comprising scenes of the seafloor 501 may be obtained from the same, single camera or image sensor of the camera system 530, or may be obtained from multiple cameras or image sensors of the camera system 530. In examples where the ROV 575 includes multiple cameras, the multiple cameras can be included in the same camera system 530, or may be included in multiple, different pattern detection camera system 530. The multiple cameras, when present, can correspond to a same, single reference location or can correspond to respective, individual reference locations (e.g., one reference location for each camera of the multiple cameras, when present, etc.). In some aspects, multiple cameras and/or pattern detection camera system 530 can be provided at different attachment locations (and different reference locations) on the ROV 575, for example where the multiple cameras are configured and positioned to provide improved viewing angle and viewing coverage of the seafloor surface 501 below the ROV 5075.

In some examples, the use of multiple cameras and/or multiple pattern detection camera system 530 can be used to provide increased pose flexibility of the ROV 575, where the ROV 575 can perform capture of image frames without being forced into the same image capture pose that may be associated with single camera system 530 implementations. For example, each camera or camera system 530 of the multiple cameras/camera systems 530, when present, can have one or more different image capture poses for the ROV 575, such that the ROV 575 can use the multiple cameras/camera systems 530 to perform image frame capture using a selected image capture pose out of the plurality of available image capture poses, etc. In some cases, the camera system 530 and/or ROV 575 can include one or more strobes or other lighting systems configured to provide illumination of the seafloor 501 scene and the seismic node 505 with configured tracking pattern 215 disposed thereupon. In some aspects, each camera of one or more cameras/camera system 530 included on or attached to the ROV 575 may run a corresponding separate instance of a computer vision-based pattern detection software for detecting the configured pattern 215 on the seismic nodes 505.

The computer vision pattern detection software can be used to perform the detection of the configured pattern 215 on the seismic node 505, and can be used to determine a calculated offset (e.g., Δxyz) between the reference point of the camera system 530 (e.g., the focal point location of the camera of the camera system 530) and the location of the configured pattern 215 on the top/upper surface 507 of the seismic node 505. In some aspects, the calculated offset between the reference point of the camera system 530 (e.g., the focal point location of the camera of the camera system 530) and the location of the configured pattern 215 on the top/upper surface 507 of the seismic node 505 can be determined based on the reference point location for the camera system 530 focal center (e.g., the location or center of the image sensor of the camera used by the camera system 530 to capture the frame of image data depicting the configured pattern 215 on the seismic node 505 upper surface 507, etc.) and a boresight of the camera system 530. In some aspects, the boresight of the camera system 530 can be the optical imaging axis of the camera of the camera system 530 that captures the frame of image data for which the pattern detection is performed for the configured pattern 215 provided on the upper surface 507 of the seismic node 505.

In some embodiments, the pattern detection camera system 530 can implement real-time processing for the detection and/or recognition of the configured pattern(s) 215 attached to the seismic nodes 505. The pattern detection and/or recognition processing performed by or for the camera system 530 can be implemented by onboard the ROV 575 in substantially real-time, for example using one or more processors included in the camera system 530 and/or using one or more onboard, local processors included in and implemented by the ROV 575, etc.

In some cases, the pattern detection camera system 530 can be configured to detect and track multiple instances of configured patterns 515 within the same FOV (e.g., within the same captured image frame, or series of multiple captured image frames), in examples where different seismic nodes 505 are attached to corresponding, different configured patterns 215. For example, when a 1:1 mapping between seismic nodes 505 and configured tracking patterns 215 is implemented, the camera system 530 can detect and track the corresponding tracking pattern 215 (e.g., which is unique for each seismic node 505) for multiple instances of the unique tracking patterns that may be present for multiple seismic nodes 505 imaged within a same frame of image data captured by camera system 530. As noted above, in the 1:1 implementation of unique t racking patterns 215 for each respective seismic node 505, mapping information can be used to indicate the correspondence between a particular node ID (e.g., identifier of a particular seismic node 505 of the plurality of seismic nodes) and a particular tracking pattern ID (e.g., identifier of a particular, unique tracking pattern 215). In some cases, the mapping information or database information showing the correspondence between seismic node 505 node IDs and tracking pattern 215 pattern IDs can be stored locally in a database or onboard storage included in the ROV 575. In other examples, the tracking pattern 215 is reused across some, or all, of the plurality of seismic nodes 505, and the deployment of the seismic nodes 505 is spaced to correspond to image frame captures by the camera system 530 of the ROV 575 such that the FOV of the captured imaged frames depicts at most a single instance of the shared/common tracking pattern 215 (e.g., the FOV of the captured image frames depicts at most a single seismic node 505 on the seafloor 501 surface, etc.) In some aspects, the pattern recognition camera system 530 attached to the moveable subsea unit (e.g., ROV 575) can be further configured to calculate a relative offset (e.g., the calculated offset Δxyz shown in FIG. 5) from a reference location of the camera system, shown in FIG. 5 as the camera reference location 531 (e.g., which may be the focal center of the camera system 530, etc.) to the location of the detected configured pattern on the upper face/surface 507 of the seismic node 505. The calculated offset may also be referred to as a “distance”, where the offset/distance between a first location and a second location includes three-dimensional information comprising a range, bearing, and azimuth between the first and second locations. The calculated offset Δxyz from the camera system 530 reference location 531 to the configured pattern on the seismic node 505 can include a distance offset (e.g., a distance between a first (x, y, z) coordinate of the camera reference point/focal center location 531 and a second (x, y, z) coordinate of the location of the configured pattern on the upper surface 507 of the seismic node 505), and/or can include an angular or orientation offset information (e.g., rotation angles or orientations about one or more of the three axes of the distance measurement (e.g., rₓ, r_{y}, r_{z}, representing rotation about the x-, y-, and z-axes respectively)). In some aspects, the angular or orientation offset information can be determined based at least in part on the boresight orientation of the camera system 530 when capturing the frame of image data for which the pattern detection was performed. For example, the camera system 530 may be rigidly fixed or coupled to the ROV frame 575, causing the camera boresight to additionally be rigidly fixed to the ROV frame 575. Movement and/or rotation of the ROV frame 575 therefore corresponds to movement and/or rotation of the camera system 530 and camera boresight that are rigidly attached relative to the ROV frame 575. In some aspects, as the ROV frame 575 moves and/or rotates in three dimensions, the systems and techniques can use the MRU 540 to obtain pitch and/or roll data corresponding to the ROV frame 575 movements and rotations, such that the MRU 540 pitch/roll data can be used to compensate for changes in the boresight alignment relative to the true vertical (e.g., vertical axis 512, etc.). As will be described in further detail below, the camera system 530 and its corresponding camera reference location 531 can be calibrated against the MRU 540 and MRU reference location 541, using a dimensional control survey process to measure the relative offset from the camera reference location 531 to the ROV frame 575 (e.g., a dimcon offset information Δ_{camera-ROV}, etc.), and to measure the relative offset from the MRU reference location 541 to the ROV frame 575 (e.g., a dimcon offset information Δ_{MRU-ROV}, etc.). To locate the detected pattern on seismic node 505, relative to the camera system 530, the MRU 540 data can be used to obtain an angular offset from the boresight to the true vertical. The pattern on seismic node 505 can be located relative to the camera system 530 based on determining the offset or distance therebetween, comprising at least a range, bearing and azimuth in three-dimensional space. Range, bearing and azimuth can be used to determine relative depth for seismic nodes 505; with the addition of absolute heading information, relative positioning may additionally be determined for the seismic nodes 505.

In some embodiments, a motion reference unit (MRU) 540 can be attached to the ROV 575, and may be used to obtain angular and/or orientation sensor data indicative of the rotation angles rₓ, r_{y}, r_{z} of the MRU 540 at the time of image capture by the camera system 530. Based on a rigid and fixed geometry attachment between the MRU 540 and the ROV 575, the pose, attitude, or orientation of the MRU 540 at the time of image capture can be used as the pose, attitude, or orientation of the ROV 575 at the time of image capture, based on transforming the measured pose/attitude information from the location of the MRU 540 on the ROV 575 to the reference point (e.g., origin location of the ROV 575 reference frame or coordinate system). Similarly, the measure pose/attitude/orientation or rotation information for the camera system 530 at the time of image capture can be obtained by transforming the measured pose/attitude sensor data values from the MRU 540 (e.g., corresponding to the MRU reference location 541) to the reference location 531 of the camera system 530.

In one illustrative example, the systems and techniques can be configured to combine vision tracking data (e.g., the calculated offset Δxyz shown in FIG. 5) from the camera system 530 (e.g., at the camera reference location 531) to the seismic node 505 (e.g., at the detected location on the upper node surface 507 where the configured tracking pattern is attached); MRU 540 orientation data (e.g., at the MRU reference location 541); and pressure and/or pressure-based derived depth information obtained using the one or more pressure sensors of the pressure sensor array 550 attached to the ROV 575 (e.g., at the pressure reference location 551 configured for and shared by the one or more pressure sensors included in the pressure sensors array 550).

The combining of the measurement information from the camera system 530, pressure sensor array 550, and MRU 540—each attached to the ROV 575 and associated with a respective reference location 531, 551, 541—can be performed based on accurate dimensional control survey information that is determined previously for the fixed geometry between the reference locations 531, 551, 541 on the ROV 575 body. The dimensional control survey information can be performed prior to operations with the ROV 575 to deploy, retrieve, and/or monitor the seismic nodes 505 on the seafloor 501 surface. The dimensional control survey information can be indicative of the precise 3D locations (e.g., (x, y, z) coordinates) of each reference location 531, 541, 551 and/or indicative of the precise 3D offsets (e.g., Δxyz) between different pairs of the reference locations 531, 541, 551.

For example, the dimensional control survey information can be indicative of the offset between the camera system 530 reference location 531 and the MRU 540 reference location 541, shown in FIG. 5 as the camera-to-MRU offset Δz_{camera-MRU}. In some embodiments, to indicate the Δz offset between the camera system and the MRU (e.g., the camera-to-MRU offset Δz_{camera-MRU}), the dimensional control survey can indicate or include a first offset information of the camera system 530 reference location 531 relative to the fixed ROV frame 575, and can indicate or include a second offset information of the MRU 540 reference location 541 relative to the same point on the fixed ROV frame 575. For instance, the dimensional control survey information may indicate the relative Δz offset between each of the sensor reference locations 531 (for the camera system 530), 541 (for the MRU 540), and 551 (for the pressure sensor array 550). The relative Δz offset from each sensor reference 531, 541, 551 can be relative to a point on the fixed ROV frame 575, which in one illustrative example is a central point at the origin, a point at the center of mass, center of gravity, center of buoyancy, etc., that is selected or configured for use as the fixed reference on ROV frame 575. In some examples, the relative Δz offset determined by the dimensional control survey can be from the respective sensor reference locations 531, 541, 551 to the origin of the ROV frame 575 (e.g., the origin or zero point of the vertical ROV frame 575 reference axis 512, etc.). Subsequently, the different relative Δz offsets between individual sensors can be used to calculate absolute offset information between the sensors by using the MRU 540 sensor data (e.g., attitude, pose, orientation, etc.) to calculate the absolute offset from the dimensional control survey relative offsets. In one illustrative example, the camera-to-MRU offset Δz_{camera-MRU} can be determined as a derived absolute offset calculated using the relative offset Δz_{camera-ROV}, the relative offset Δz_{MRU-ROV}, and the MRU 540 data. In another example, the dimensional control survey information can be indicative of the offset between the camera system 530 reference location 531 and the pressure sensor array 550 reference location 551, shown in FIG. 5 as the camera-to-pressure array offset Δz_{camera-pressure.}

In some embodiments, the dimensional control information (e.g., dimensional calibration information) can be obtained indicative of the precise three-dimensional offsets (e.g., distances and orientations, etc.) and lever arms between the reference point 531 of the pattern recognition camera system 530 attached to the moveable subsea unit/ROV 575 (e.g., a first reference point 531 comprising the camera system 530 focal center), the reference point 551 of the pressure sensor array 550 (e.g., a second reference point 551 comprising the configured reference location for the one or more pressure sensors attached to the moveable subsea unit/ROV 575 and included in the pressure sensor array 550), and a reference point 541 of the MRU 540 or other orientation sensor(s) attached to the ROV 575 and configured to provide orientation, attitude, and/or pose information corresponding to the ROV 575 (e.g., a third reference point 541 comprising a configured reference location for the MRU 540 attached to the ROV 575).

In some embodiments, the dimensional control information can be further indicative of and/or can further include respective orientation or rotation information for each of the camera system 530 (and camera reference location 531), MRU 540 (and MRU reference location 541, and pressure sensor array 550 (and pressure array reference location 551). The orientation or rotation information can be indicative of the rotation of each of the camera system 530, MRU 540, and pressure sensor array 550 relative to a common reference point, which in some aspects can be provided as the origin or center point of the ROV 575 and/or reference frame of the ROV (e.g., the origin of the coordinate system having the vertical axis 512λ shown in FIG. 5, etc.). The relative orientation or rotation information of the camera system 530 can be the relative rotation information rₓ, r_{y}, r_{z} between the camera system 530 boresight and the origin of the vertical axis 512λ of the ROV 575 frame. The relative orientation or rotation information of the MRU 540 can be the relative rotation information rₓ, r_{y}, r_{z} between the coordinate frame of the MRU 540 at MRU reference location 541 and the origin of the vertical axis 512λ of the ROV 575 frame. Likewise, the relative orientation or rotation information of the pressure sensor array 550 can be the relative rotation information rₓ, r_{y}, r_{z} between the coordinate frame of the pressure sensor array 550 at pressure array reference location 551, and the origin of the vertical axis 512λ of the ROV 575 frame.

Based on the dimensional control information indicative of the precise 3D offsets and lever arms, as well as the relative orientation information, between each of the reference locations 531, 541, and 551 to a common reference location (e.g., the origin of the vertical axis 512λ of the ROV 575 frame, etc.), measurements can be transformed and/or projected from the respective reference location 531, 541, 551 of one of the sensor sub-systems of the ROV 575 (e.g., camera system 530, MRU 540, pressure sensor array 550, respectively) to another, different respective reference location for a different sensor sub-system on the ROV 575. The projection can be based on the assumption that once installed, each of the sensor subsystems 530, 540, 550 of the ROV 575 will remain rigidly fixed and attached to the ROV 575, and will not undergo relative movement with respect to the remaining sensor subsystems or the ROV reference frame corresponding to the vertical axis 512λ of the ROV 575 frame. In response to a relative movement of one or more of the sensor subsystems 530, 540, 550 and/or corresponding reference locations 531, 541, 551, a re-survey can be performed to obtain updated dimensional control information for the new configuration geometry In one illustrative example, the systems and techniques can be used to determine a derived relative depth of the seismic node 505 (e.g., relative to a reference depth, such as the reference depth 325 of FIG. 3 and/or a reference depth information provided by a benchmark reference depth structure such as the benchmarks 460, 460-N, etc. of FIG. 4, etc.) by determining a derived relative depth of the configured tracking pattern 215 on the top surface 507 of the seismic node 505. The derived relative depth information can be determined based on the three data sources provided by the camera system 530, adjusted or projected corresponding to the dimensional control information for the camera system 530 boresight and reference location 531; the MRU 540, adjusted or projected corresponding to the dimensional control information for the MRU 540 reference location 541; and the pressure sensor array 550, adjusted or projected corresponding to the dimensional control information for the pressure array 550 reference location 551.

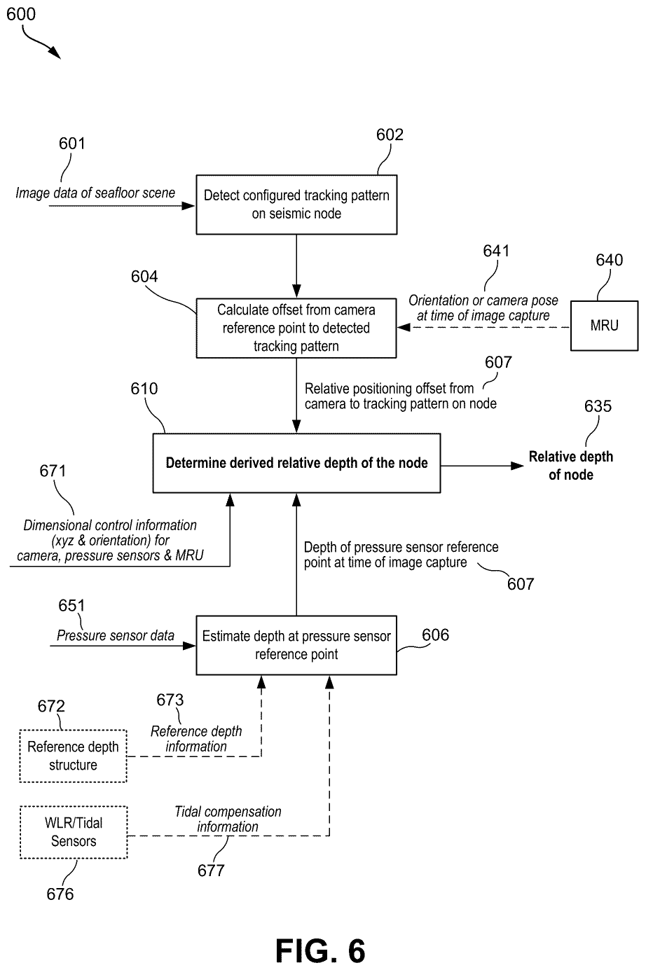

For example, FIG. 6 is a flow diagram illustrating an example of a process 600 for determining derived relative depth information for a seismic node, in accordance with some examples. In some aspects, the process 600 can be performed to determine a derived relative depth of the seismic node 505 of FIG. 5.

In one illustrative example, to determine a derived relative depth 635 of a configured tracking pattern 215 on the upper face/surface 507 of the seismic node 505 of FIG. 5 (and thereby, determine the derived relative depth of the seismic node 505 itself), the process 600 can include, at block 606, determining a depth of the moveable subsea unit/ROV 575 at a time of capture for the image frame for which the configured pattern was detected and recognized.

For instance, at block 606, the process can include estimating the depth information corresponding to the pressure sensor array reference point 551 configured for the pressure sensor array 550. The pressure sensor data 651 used as input for the determination of the depth information can be pressure sensor data 651 measured by the pressure sensor array 550 at the pressure array reference location 551. The derived depth 607 can be the depth of the pressure sensor array reference location 551, at the time of capturing the image frame depicting the configured tracking pattern 215 on the seismic node 505, the image frame captured by the camera system 530. The derived depth 607 can be determined at block 606 using the pressure sensor data 651 as input to the hydrostatic equation to obtain as output the derived depth 607, as described previously above.

In some aspects, at block 606, the estimation of the depth at the pressure sensor array 550 reference location 551 can be further based on reference depth information 673 obtained from a reference depth structure 672, such as reference depth information 673 corresponding to the configured depth reference 325 of FIG. 3 and/or reference depth information 673 corresponding to a reference depth of a benchmark depth structure 460, 460-N of FIG. 4, etc. The reference depth structure 672 can be the same as or similar to the benchmark depth structure(s) 460, 460-N of FIG. 4, and the reference depth information 673 can be the benchmark depth for the OBN survey field. In examples where reference depth information 673 is provided as input to the depth estimation at block 606 to determine the estimated depth of the pressure array 550 on the ROV 575, the output of block 606 (e.g., the estimated depth of the pressure sensor reference point at the time of image capture, 607) can be a relative depth that is referenced to the reference depth structure 672 (e.g., benchmark depth structure or frame, 460 or 460-N, etc.) and the reference depth information 673.

In some embodiments, the reference depth structure 672 can be visited first, for example the ROV can visit the reference depth structure 672 first, before checking/determining the relative depth information for the seismic nodes. By visiting the reference depth structure 672 before the relative node depth derivation described previously above, the relative depth derivation process can start from tared pressure readings, based on the taring process performed to tare pressure sensors on the ROV (e.g., such as the pressure sensor array 550 of FIG. 5, etc.) with pressure sensors on the reference depth structure 672. In some embodiments, the ROV can visit the reference structure(s) and may be configured to interrogate an acoustic device that is interfaced to the pressure sensors, to thereby obtain real-time or near-real-time observations. For example, a small delay may be present in the elapsed time for the ROV to receive a signal from the reference depth structure 672 that indicates the preference pressure reading at the reference depth structure 672 (e.g., the received signal received by the ROV after interrogating the acoustic device at the reference depth structure 672, etc.). The delay in time between when the reference pressure was measured at the reference depth structure 672, and the time when the pressure is measured at the ROV for taring, can be compensated using timestamping information from the camera tracking system 530. For instance, the ROV performs pattern tracking of a pattern on the reference depth structure using the camera system 530, and accordingly can use the timestamp information from the camera system 530 tracking images to determine the corresponding MRU 540 orientation/pose/attitude data that indicates or can be used to derive the precise locations of where the ROV sensor(s) were at any particular time. Additionally, performing matching (e.g., taring) between a delayed reference pressure reading from the reference depth structure 672, and the current pressure reading from the pressure sensor array 550 at the ROV 575, may have a negligible error based on the relatively short period of time for which the reference pressure reading from the reference depth structure 672 is delayed (e.g., approximately corresponding to the speed of sound in water divided by the range between the ROV and reference depth structure, etc.). Tidal effects can be approximated as zero over the short time period of the reference reading delay time.

At a later time, after initial pressure sensor taring prior to the ROV visiting seismic nodes to determine the derived relative depth information, the ROV may revisit the reference depth structure 672 to perform the taring process again and/or to verify if the pressure sensors are still tared to one another (e.g., within a configured threshold of accuracy, or permissible drift in the taring, etc.). In some aspects, if the ROV determines upon revisiting the reference depth structure 672 that the pressure sensors are no longer tared to each other, or have drifted to exceed a configured threshold amount or percentage, the ROV can re-tare and/or can determine a time-based drift correction corresponding to the pressure sensors drifting out of the tared configuration initially established at the earlier visit to the reference depth structure 672. The time-based drift correction can be used to perform correction of earlier derived depth measurements the ROV determined for seismic nodes, to remove the effect or error introduced by the pressure sensor array 550 drifting out of the tared reading with the reference depth structure 672. In some embodiments, the systems and techniques can perform pressure sensor taring by deploying a sensor device or sensor node that includes one or more accurate attitude sensors integrated within or attached thereto, with internal batteries that power the sensor device and the external reference pressure sensors. By interrogating the deployed sensor device (e.g., acoustic interrogation using an acoustic transmitter/transducer of the ROV, and an acoustic receiver/transducer of the deployed sensor device, etc.), the ROV can obtain reference pressure reading(s) of the deployed sensor device, and can additionally obtain accurate attitude information of the deployed sensor device, as measured by the accurate attitude sensors included in the deployed sensor device. In some aspects, the deployed sensor device may include an attached pattern for detection and tracking by the camera system 530 of the ROV, as has been described previously above with respect to the various configured patterns that can be detected and tracked in the captured image data of the ROV camera system 530. In another example, the reference pattern can be applied to the frame in which the dimensional control survey information is obtained in (e.g., the pattern may be applied to the frame in which dimension control surveying relative to the pressure sensor 550 was performed).

In both examples of the pressure sensor taring (e.g., using an existing reference depth structure 672, and/or using a deployed sensor device with or without additional attitude sensors), the systems and techniques can be configured to apply the WLR and/or tidal effect corrections (e.g., associated with the WLR/tidal sensors 676 and the tidal compensation information 677 of FIG. 6), as post-processing operations after the completion of the seismic survey. In some aspects, the tidal compensation information 677 is obtained asynchronously from the pressure sensor data measurements at the ROV, for example, based on the tidal compensation information 677 being retrieved from the WLR/tidal sensors 676 at some other point in time that is not necessarily during the deployment of the seismic nodes 505 or the recovery of the seismic nodes 505. The tidal compensation information 677 can be obtained or retrieved from the WLR/tidal sensors 676 by the ROV associated with the seismic nodes 505, and/or can be retrieved using other means. The tidal compensation applied using the tidal compensation information 677 can be a time-based compensation (e.g., tide data is compensated for based on time).

In some embodiments, at block 606, the estimation of the depth at the pressure sensor array 550 reference location 551 can be further based on tidal compensation information 677 obtained from one or more WLR or tidal sensors 676, as described previously above with respect to FIG. 4. For example, the one or more WLR or tidal sensors 676 can be the same as or similar to the WLRs 480, 480-2, 480-n, . . . , etc., shown in the example of FIG. 4, among various other examples of tidal sensors or water depth gauges or monitors, etc. In examples where the tidal compensation information 677 is an input to the depth estimation of the pressure sensor array 550 at block 606, the estimated pressure sensor array depth information 607 generated as output can be tidally compensated to remove the cyclical variation in pressure, and therefore derived depth, associated with tidal effects increasing and decreasing the height of the water column above the OBN survey field on the seafloor surface.

The depth information 607 of the pressure sensor reference point 551 for the pressure sensor array 550 on the ROV 575 can be a first input to the block 610 determination of the derived relative depth of the seismic node 505.

An additional input to the block 610 determination of the derived relative depth of the seismic node 505 can comprise the relative positioning offset information 607 from the camera system 530 (e.g., the camera reference location 531 at the camera system 530 focal center, etc.) to the detected tracking pattern on the top surface 507 of the seismic node 505 that is imaged in the captured frame of image data.

For example, image data of a seafloor scene 601 can be obtained and used to detect, at block 602, the configured tracking pattern on a seismic node (e.g., seismic node 505, etc.). The captured frame of image data 601 can be a captured frame of image data obtained by the camera system 530 of FIG. 5, corresponding to a scene of the seafloor 501 and the seismic node 505 with the configured tracking pattern 215 attached to the top surface 507 of the seismic node 505. The detection of the configured tracking pattern at block 602 can be a detection process implemented by the pattern detection camera system 530, in at least some examples.

At block 604, in response to detection of the configured tracking pattern 215 at block 602, the process 600 can include calculating an offset form the camera reference point 531 to the detected tracking pattern 215 in the image data 601 (e.g., the detected tracking pattern 215 physically attached to the upper surface 507 of the seismic node 505). The offset calculated at block 604 can be the same as or similar to the offset Δxyz shown in FIG. 5 between the camera system 530 focal center reference point 531 to the seismic node 505 with tracking pattern disposed thereupon.

In some examples, the calculation of the offset from the camera reference point 531 to the seismic node 505 tracking pattern 215 can, at block 604, be further based on orientation information indicative of a camera pose at the time of image capture for the image frame data 601. For example, block 604 can receive orientation or pose or attitude information 641 from the MRU 640 (e.g., the same as or similar to the MRU 540 of FIG. 5) that corresponds to the time of capture for the frame of image data 601 in which the configured tracking pattern 215 was detected at block 602. Based on the orientation or attitude information 641 from the MRU 640, and further based on the dimensional control information corresponding to the geometric offset and angular relative orientation or rotation between the MRU 640/540 and the camera system 530, the orientation or pose or attitude of the camera system can be obtained as a projection of the MRU 640/540 orientation information 641. The projected camera system 530 orientation information from the MRU 640/540 orientation information 641 can be used to compensate or adjust the calculated offset 607 determined at block 604 between the camera reference point 531 and the seismic node 505 tracking pattern 215.

In some aspects, the pattern detection camera system 530 can be attached to the moveable subsea unit 575 at a first location 531, and a pressure sensor array 530 (e.g., comprising one or more pressure sensors) can be attached to the moveable subsea unit 575 at a second, reference location 551 (e.g., a reference location 551 shared by the one or more pressure sensors of the pressure sensor array 550). The pressure sensor array 550 can be used to determine a depth of the moveable subsea unit 575 at block 606 of the process 600 of FIG. 6, for example based on obtaining a pressure reading corresponding to the current depth of the pressure sensor array 550 at location 551, and deriving a current depth 607 of the reference location 551 for the pressure sensor array 550 from the pressure reading 651. In some aspects, the depth information 607 can be derived from hydrostatic pressure as measured by the pressure sensor array 550 attached to the moveable subsea unit 575 at the reference location 551. The hydrostatic pressure 651 can be converted to a derived depth 607 of the reference location 551 of the pressure sensor array 550 on the moveable subsea unit 575 (e.g., reference location 551 where the pressure sensor array 550 is attached to or provided upon the ROV 575, etc.). For example, the hydrostatic pressure 651 measured by the pressure sensor array 550 can be used to derive the reference location 551 depth information 607 using a hydrostatic pressure calculation that incorporates the density of the water column, gravity, hydrostatic pressure 651, and barometric pressure to obtain the derived depth 607, at block 606.

At block 610, the process 600 can include determining the derived relative depth of the seismic node 505, based on combining the depth information 607 for the pressure sensor reference point 551 with the calculated, computer vision-based relative positioning offset 607 between the pattern detection camera system 530 reference location 531 and the configured tracking pattern 215 on the upper surface 507 of the seismic node 505. In some aspects, the relative positioning offset 607 comprises a depth offset (e.g., z-axis only) indicative of the relative depth or vertical offset between the camera system 530 focal point 531 and the tracking pattern 215 on the upper surface of the seismic node 505. Similarly, the depth of the pressure sensor reference point 607 can be a relative depth, referenced to the benchmark structure 672 (e.g., 460, 460-N of FIG. 4, etc.) reference depth 325 (e.g., of FIG. 3, etc.).

The derived relative depth 635 of the seismic node 505 can be determined as the combination of the camera system 530 to node 505 depth (e.g., vertical or z-offset) 607, plus the dimensional control information-based geometric offset or fixed separation and angular orientation difference between the camera reference location 531 and the pressure sensor array 550 reference location 551, plus the relative depth from the pressure sensor array 550 reference location 551 to the configured reference depth 673 (e.g., reference depth 325 of FIG. 3, provided by benchmark depth reference structure 460, 460-N of FIG. 4 and/or reference depth structure 672 of FIG. 6, etc.).

In some aspects, the process 600 for determining relative depth of a seismic node (e.g., seismic node 505, etc.) can be performed as a non-contact depth determination that is relative to a configured reference depth (e.g., reference depth 325 of FIG. 3 and/or a reference depth corresponding to a benchmark reference depth structure 460, 460-N of FIG. 4, etc.). The non-contact relative depth determination for seismic nodes can be a non-contact relative depth that is determined based on combining a first depth information, obtained based on the computer vision-based depth calculation using the pattern detection camera system 530, with a second depth information obtained as a hydrostatic pressure-based depth derivation using the pressure sensor array 550 attached to the ROV or moveable subsea unit 575. The offset and orientation relative difference between the reference location 531 at which the camera system 530 depth to the tracking pattern 215 on the seismic node is calculated, and between the reference location 551 at which the pressure sensor array 540 depth from hydrostatic pressure is calculated, can be obtained from the dimensional control survey information of the ROV 575 geometric or physical configuration, and can be used to combine the machine vision-based depth from the camera system 530 to the seismic node 505 with the pressure array 550-based relative depth from the benchmark depth reference structure 460, 460-N.

In some aspects, the systems and techniques can be used to perform a taring process for taring the one or more pressure sensors of the pressure sensor array 550, wherein the taring process is configured to tare (e.g., zero, reference to a common baseline or zero point, etc.) each pressure sensor of the one or more pressure sensors of the pressure sensor array 550 to a common baseline provided by the configured depth reference 325 of FIG. 3 and/or benchmark reference depth structure 460, 460-N of FIG. 4. In some aspects, the taring process implemented according to the disclosed systems and techniques can be used for zeroing out the pressure sensor readings of the individual pressure sensors of the pressure sensor array 550 and/or pressure sensors otherwise provided by or on the ROV 575. For example, the pressure sensor readings of the pressure sensors of the ROV 575 and/or pressure sensor array 550 can be zeroed out by removing a respective residual associated with each individual pressure sensor and its corresponding pressure reading. By performing the taring and zeroing out the individual pressure sensors, the tared pressure sensors and tared pressure sensor readings can be more accurately compared against one another.

In some aspects, the pressure sensors can be tared based on a comparison between the pressure sensor being tared and a reference pressure sensor against which the tared pressure sensor is zeroed. For example, the difference between the pressure sensor being tared and the reference pressure sensor providing the zero can be used as the residual value that is to be removed (e.g., subtracted from the readings of the pressure sensor being tared) from the pressure sensor being tared. In one illustrative example, a first and second pressure sensor located at precisely the same depth, and at the same water temperature (e.g., more generally, two pressure sensors at the same depth, water temperature, and all other factors equal), then the respective pressure reading from the first of the two pressure sensors should be the same as the respective pressure reading from the second of the two pressure sensors.

In many examples, two pressure sensors held at the same depth and temperature with all other factors also held equal will not provide the same exact pressure reading, based at least in part on inherent imperfections, variations, and/or limitations in the manufacture and the fundamental precision achievable using the two pressure sensors. For the systems and techniques described herein to obtain accurate derived, relative depth values for seismic nodes 505 deployed to the seafloor surface 501, reducing the difference or variation between the pressure sensor reading obtained by the ROV 575 pressure sensor array 550 and the pressure sensor reading obtained by one or more pressure sensors attached to the benchmark depth reference structure 460, 460-N benefit from being minimized or otherwise reduced to as close to zero as can be achieved. In particular, the ROV 575 pressure sensor array 550 should read the exact same pressure reading as the pressure sensors of the benchmark structure 460, 460-N when the pressure sensor array 550 is located (e.g., the pressure reference location 551 is located) at the configured reference depth 325 that corresponds to the benchmark structure 460, 460-N pressure reading.

The ROV 575 is not deployed upon or attached to the seafloor surface 501, as the benchmark depth structure may be. As such, the ROV 575, and the attached pressure sensor array 550, may be dynamically moving relative to the fixed benchmark depth structure. The dynamic movement of the ROV 575 can make it challenging to align the pressure sensor array 550 and the pressure array reference location 551 on the ROV 575, with the depth sensors of the benchmark depth structure at the configured reference depth (e.g., as would be needed in a conventional taring process, where the two pressure sensors are exactly aligned and then zeroed to have the same reading as one another). To perform pressure sensor taring between the ROV 575 pressure sensor array 550 and one or more pressure sensors of the benchmark depth structure, where the pressure sensor taring can automatically compensate for the dynamic movement of the ROV 575 relative to the benchmark depth structure, the systems and techniques can be configured to compensate for the physical movements of the ROV 575 by using the camera system 530 to determine a relative offset from the camera system 530 reference location 531 to a configured tracking pattern that is attached to the benchmark depth structure.

In some embodiments, the configured tracking pattern attached to the benchmark depth structure and used for the pressure sensor taring may be the same as or similar to the configured tracking pattern(s) used for determining the relative distance or offset from the camera system 530 to each seismic node 505. In one illustrative example, the pressure sensor taring can include determining a relative offset from the camera system 530 reference location 531 to a tracking pattern attached to the benchmark depth structure, where the benchmark depth structure relative offset determination process can be the same as or similar to the process described above for determining the offset Δxyz shown in FIG. 5 between the camera system 530 focal center reference point 531 to the seismic node 505 with tracking pattern disposed thereupon.

In some aspects, a corresponding tracking pattern (e.g., the same as or similar to the tracking pattern 215 of FIG. 2, etc.) can be attached to the benchmark depth reference structure. The tracking pattern mounted to the frame of the benchmark depth structure can be accurately surveyed and/or dimensional control survey information can be obtained to accurately position the benchmark structure tracking pattern as a precise relative location in 3D space (e.g., 3D xyz coordinate or offset) and orientation (e.g., 3D rotation angles rₓ, r_{y}, and r_{z}). By tracking the configured tracking pattern attached to the benchmark depth structure, using the camera system 530 of the ROV 575, the systems and techniques can determine the relative Δxyz offset from the camera reference location 531 to the surveyed xyz location of the tracking pattern attached to the benchmark depth structure. The systems and techniques can additionally determine the relative orientation offset from the camera system 530 reference location 531 on the ROV 575, to the surveyed location of the tracking pattern attached with a surveyed orientation to the benchmark depth structure.

Known dimensional control surveying information can be used to offset the camera system 530 reference location 531 to the location 551 of the pressure sensor array 550 on the ROV 575 (e.g., based on the pressure sensor array 550 being tared against the pressure sensor(s) of the benchmark depth structure), and can additionally be used to offset the surveyed location of the tracking pattern on the benchmark depth structure to the corresponding reference location of the pressure sensor(s) on the benchmark depth structure that are used to provide the configured depth reference 325.

The dynamic offset can be calculated between the pressure array 550 on the ROV 575 to the pressure sensor(s) on the benchmark depth structure, where the dynamic offset is subsequently removed to thereby remove (e.g., zero out, etc.) any residual difference between the ROV 575 pressure array sensors 550 and the benchmark depth structure pressure sensors at the configured reference depth 325. The dynamic offset information can remove the residual difference between the ROV 575 pressure reading and the benchmark depth structure pressure reading, where the ROV 575 pressure sensor array 550 is tared against the benchmark depth structure pressure sensors when this residual difference is removed to zero (e.g., by removing or subtracting the calculated dynamic offset). After the sensor taring, the absolute depth determined by the pressure sensor readings at either apparatus does not influence the derived relative depth calculated for the seismic nodes (e.g., the derived relative depth information 635, etc. Instead, the derived relative depth 635 calculated for the seismic nodes 505 may depend on the taring of the ROV 575 pressure sensor array 550 to the benchmark depth structure pressure sensors. When the ROV 575 pressure sensor array 550 and the benchmark depth structure pressure sensors have the same pressure reading at the same location corresponding to the configured depth reference 325 (and after compensation for the dynamic offset information), the two pressure readings, and therefore the two derived depths from the hydrostatic equation, are tared to one another for a period of time sufficient to conduct operations by the ROV 575. After the expiration of a configured period of time for the tared sensors to remain relatively zeroed to one another, the ROV 575 may be configured to return to the benchmark depth reference structure and repeat the taring process. If the two pressure sensor readings have drifted relative to one another, or have developed sensor bias and are no longer tared (e.g., zeroed), the repeated taring process can reset the two pressure sensor readings to again be zeroed out relative to one another, with any residual difference or bias at the configured depth reference 325 removed.

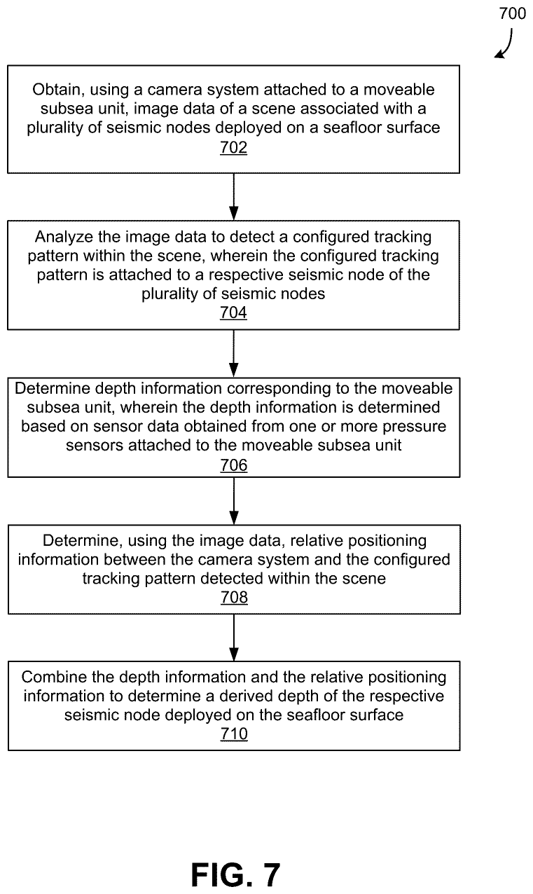

FIG. 7 is a flowchart diagram illustrating an example of a process 700 for determining relative depths of seismic nodes deployed on a seafloor surface, in accordance with some examples. For example, the process 700 can correspond to relative depth determination for a plurality of OBN seismic nodes deployed on the seafloor surface for one or more seismic surveying operations. In some aspects, at block 702, the process 700 can include obtaining, using a camera system attached to a moveable subsea unit, image data of a scene associated with a plurality of seismic nodes deployed on a seafloor surface. At block 704, the process 700 can include analyzing the image data to detect a configured tracking pattern within the scene, wherein the configured tracking pattern is attached to a At block 706, the process 700 can include determining depth information corresponding to the moveable subsea unit, wherein the depth information is determined based on sensor data obtained from one or more pressure sensors attached to the moveable subsea unit. At block 708, the process 700 can include determining, using the image data, relative positioning information between the camera system and the configured tracking pattern detected within the scene. At block 710, the process 700 can include combining the depth information and the relative positioning information to determine a derived depth of the respective seismic node deployed on the seafloor surface.

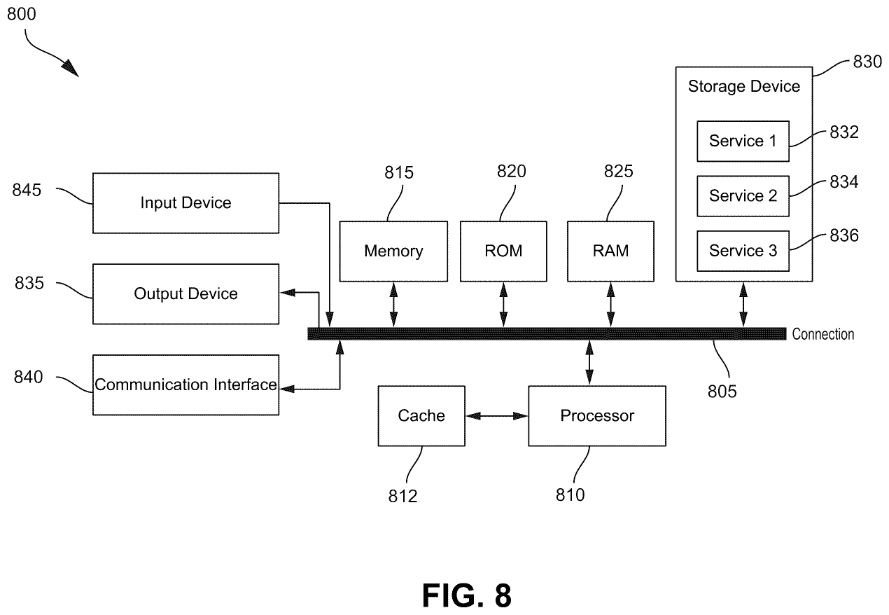

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices. Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A method comprising:
obtaining, using a camera system attached to a moveable subsea unit, image data of a scene associated with a plurality of seismic nodes deployed on a seafloor surface;
analyzing the image data to detect a configured tracking pattern within the scene, wherein the configured tracking pattern is attached to a respective seismic node of the plurality of seismic nodes;
determining depth information corresponding to the moveable subsea unit, wherein the depth information is determined based on sensor data obtained from one or more pressure sensors attached to the moveable subsea unit;
determining, using the image data, relative positioning information between the camera system and the configured tracking pattern detected within the scene; and
combining the depth information and the relative positioning information to determine a derived depth of the respective seismic node deployed on the seafloor surface.

2. The method of claim 1, wherein:
the depth information comprises a pressure-based relative depth estimation corresponding to the moveable subsea unit;
the relative positioning information comprises a computer vision-based vertical offset from the moveable subsea unit to the respective seismic node; and
the derived depth of the respective seismic node comprises relative depth information for the respective seismic node.

3. The method of claim 1, wherein combining the depth information and the relative positioning information includes:
obtaining information indicative of an offset between the camera system attached to the moveable subsea unit and the one or more pressure sensors attached to the moveable subsea unit;
combining the depth information with the relative positioning information according to the offset; and
determining the derived depth of the respective seismic node based on the combining.

4. The method of claim 3, wherein the information indicative of the offset is based on one or more of:
a fixed geometry between a focal point of the camera system and a reference point of the one or more pressure sensors attached to the moveable subsea unit;
pose information associated with the camera system; and
pose information associated with the one or more pressure sensors.

5. The method of claim 3, wherein:
the offset between the camera system and the one or more pressure sensors includes a first vertical offset and an angular offset, wherein the angular offset is based on the pose information associated with the camera system and the pose information associated with the one or more pressure sensors;
the relative positioning information comprises a second vertical offset between the camera system and the configured tracking pattern, wherein the second vertical offset is determined using the pose information associated with the camera sensor; and
the derived depth of the respective seismic node is a sum of the depth information, the first vertical offset, and the second vertical offset.

6. The method of claim 1, wherein the relative positioning information includes:
a relative distance between the camera system and the configured tracking pattern attached to the respective seismic node, wherein the camera system is configured to estimate the relative distance using the image data of the scene in response to detection of the configured tracking pattern; and
orientation information indicative of an angular offset of the camera away from a vertical depth axis.

7. The method of claim 6, further comprising:
correcting the relative distance between the camera system and the configured tracking pattern based on the orientation information, to thereby generate corrected relative distance information, wherein the corrected relative distance information is aligned with the vertical depth axis; and
combining the depth information and the corrected relative distance information to determine the derived depth of the respective seismic node deployed on the seafloor surface.

8. The method of claim 7, wherein the corrected relative distance information comprises a vertical offset between the camera system and the respective seismic node along the vertical depth axis.

9. The method of claim 1, wherein determining the relative positioning information includes determining an attitude of the camera system, the attitude determined corresponding to a time of capture of the image data by the camera system.

10. The method of claim 9, wherein the attitude of the camera system is determined based on additional sensor data obtained from one or more Motion Reference Units (MRUs) included in the moveable subsea unit.

11. The method of claim 1, wherein:
the depth information corresponding to the moveable subsea unit is determined relative to a configured reference depth; and
the derived depth of the respective seismic node is determined relative to the same configured reference depth.

12. The method of claim 11, wherein the configured reference depth is based on a pressure measurement obtained corresponding to a subsea benchmark structure having the configured reference depth.

13. The method of claim 11, wherein the derived depth of the respective seismic node comprises a relative depth referenced to the configured reference depth based on the depth information.

14. The method of claim 11, further comprising:
taring the one or more pressure sensors attached to the moveable subsea unit, the taring performed based on a measurement of the configured reference depth; and
determining the depth information corresponding to the moveable subsea unit based on sensor data obtained from the one or more pressure sensors after taring the one or more pressure sensors.

15. The method of claim 1, wherein the moveable subsea unit comprises a remote operate vehicle (ROV) deployed within a water column above the seafloor surface.

16. The method of claim 1, further comprising:
determining a respective derived depth for each seismic node of the plurality of seismic nodes deployed on the seafloor surface,
wherein the respective derived depth for each seismic node is determined using a pressure-based depth estimate obtained from the one or more pressure sensors and a computer vision-based depth estimate obtained from image data of a corresponding tracking pattern attached to each seismic node.

17. The method of claim 16, wherein the respective derived depth for each seismic node of the plurality of seismic nodes is referenced to a same configured reference depth.

18. The method of claim 16, further comprising processing the image data obtained for each seismic node of the plurality of seismic nodes to generate point-cloud imagery corresponding to one or more of: at least a subset of the plurality of seismic nodes, or a survey field comprising the plurality of seismic nodes deployed on the seafloor surface.

19. The method of claim 1, further comprising:
obtaining time-series data indicative of one or more tidal variations associated with a seafloor area corresponding to the plurality of seismic nodes;
generating refined pressure data measurements based on using the time-series data to perform tidal compensation of the sensor data obtained from the one or more pressure sensors; and
determining the depth information corresponding to the moveable subsea unit based on the refined pressure data measurements.

20. A system for determining relative depths of seismic nodes, the system comprising:
a moveable subsea unit;
a camera system attached to the moveable subsea unit at a first attachment location;
one or more pressure sensors attached to the moveable subsea unit and associated with a second attachment location, wherein the second attachment location is a reference location for the one or more pressure sensors;
at least one processor; and
a memory storing instructions which when executed by the at least one processor, causes the at least one processor to:
obtain, using the camera system, image data of a scene associated with a plurality of seismic nodes deployed on a seafloor surface;
analyze the image data to detect a configured tracking pattern within the scene, wherein the configured tracking pattern is attached to a respective seismic node of the plurality of seismic nodes;
determine depth information corresponding to the moveable subsea unit, wherein the depth information is determined based on sensor data obtained from the one or more pressure sensors;
determine, using the image data, relative positioning information between the camera system and the configured tracking pattern detected within the scene; and
combine the depth information and the relative positioning information to determine a derived depth of the respective seismic node deployed on the seafloor surface.
